(19) United States
(12) Patent Application Publication
(10) Pub. No.: US 2002/0031115 A1
(43) Pub. Date: Mar. 14, 2002

(54) System and method for automatically establishing a telephone call over a computer network

(76) Inventor: Brian J. Petryna, Lebanon, NJ (US)

Correspondence Address: HITT GAINES & BOISBRUN P.C., P.O. BOX 832570, RICHARDSON, TX, 75083, US

(21) Appl. No.: 09/940,783

(22) Filed: Aug. 28, 2001

Related U.S. Application Data
(60) Provisional application No. 60/232,178, filed on Sep. 11, 2000.

(51) Int. Cl. H04L 12/66

(52) U.S. Cl. 370/352; 379/93.01

(57) ABSTRACT

A system for, and method of, automatically initiating a telephone call over a computer network and a computer incorporating the system or the method. In one embodiment, the system includes: (1) an address interceptor, associated with a station of a circuit-switched telephone network, that receives calling number identification signals from the circuit-switched telephone network and extracts therefrom a destination address and (2) a network call initiator, coupled to the address interceptor and associated with a computer network terminal, that employs the destination address to initiate the telephone call via the computer network terminal.

### CROSS-REFERENCE TO PROVISIONAL APPLICATION

This application claims the benefit of U.S. Provisional Application No. 60/232,178 entitled “SYSTEM AND METHOD FOR AUTOMATICALLY ESTABLISHING A TELEPHONE CALL OVER A COMPUTER NETWORK” to Brian J. Petryna, filed on Sep. 11, 2000, which is commonly assigned with the present invention and incorporated herein by reference as if reproduced herein in its entirety.

### TECHNICAL FIELD OF THE INVENTION

The present invention is directed, in general, to telecommunications and, more specifically, to a system and method for automatically establishing a telephone call over a computer network.

### BACKGROUND OF THE INVENTION

When a person made a long distance phone call, that person usually used one of the long distance telephone carriers. This included connecting to a local office which in turn connected to a long distance telephone carrier. The long distance telephone carrier connected to a local office at the destination and then a local call was made to the person or business. The long distance telephone carriers usually charged money based upon the distance and time the connection was active.

With the advent of the Internet, telephone calls can be made over the Internet. This is called Voice over IP (“VoIP”) and allows a person to make a local phone call and talk to another person located a distance away using the Internet. VoIP calls does not require the calls to be transmitted through any of the long distance carriers, thus saving money. VoIP, however, requires manual intervention to make phone calls. The person placing the call has to enter the phone number or Internet address before the call is made.

Accordingly, what is needed in the art is a way to initiate telephone calls over the Internet or any computer network without manual intervention.

### SUMMARY OF THE INVENTION

To address the above-discussed deficiencies of the prior art, the present invention provides a system for, and method of, automatically initiating a telephone call over a computer network and a computer incorporating the system or the method. In one embodiment, the system includes: (1) an address interceptor, associated with a station of a circuit-switched telephone network, that receives calling number identification signals from the circuit-switched telephone network and extracts therefrom a destination address and (2) a network call initiator, coupled to the address interceptor and associated with a computer network terminal, that employs the destination address to initiate the telephone call via the computer network terminal.

The present invention therefore introduces the broad concept of employing calling number identification signals (colloquially known as “Caller-ID” and taking the form of analog, in-band signals received between ringing signals) to carry a destination address (instead of a telephone number). The destination address can then be extracted from the calling number identification signals and employed automatically to initiate a call over a computer network (such as a “voice-over-IP” call over the Internet. The present invention enjoys substantial utility in that the call is initiated automatically, without requiring a person to remember and manually enter a destination address.

In one embodiment of the present invention, the calling number identification signals and the destination address are associated with a single location. Thus, a first location can place a telephone call over a circuit-switched telephone network (such as the PSTN) to a second location and cause its destination address to be transmitted to the second location by way of calling number identification signals. The second location receives the destination address and calls the first location via a computer network. Alternatively, the destination address can point to a third location dissociated from the first. In either case, a smooth transition from a telephone call over the telephone network to one over the computer network has been made to happen.

In one embodiment of the present invention, the destination address is selected from the group consisting of (1) a telephone number, (2) an Internet Protocol address, (3) a Voice over Internet Protocol (VoIP) gateway address, and (4) a VoIP gateway address combined with a telephone number. In a related embodiment, the computer network is the Internet. Of course, other protocols and networks are fully within the broad scope of the present invention.

In one embodiment of the present invention, the station leaves unanswered a call transmitting the calling number identification signals. In a related embodiment, the calling number identification signals are associated with a second station, the second station hanging up after a predetermined number of unanswered rings. It is preferable, although not necessary, that the initial call transmitting the calling number identification signals not incur charges. Were that call to be answered and completed, such would be the case. Instead, once the calling number identification signals are communicated, the inchoate call becomes superfluous. Accordingly, the receiving station is free not to answer the call, and the second station is free to hang up. The predetermined number may be two, assuming that the calling number identification signals are received between the first and second ringing signals.

In one embodiment of the present invention, the station and the computer network terminal are embodied in a computer and wherein a single telephone line alternatively couples the station to the circuit-switched telephone network and the computer network terminal to the computer network. Thus, the single line can handle both receiving the calling number identification signals and making the subsequent telephone call over the computer network. Of course, multiple lines may be used for such purposes; the present invention is not limited to a particular configuration.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a system for automatically initiating a telephone call over a computer network constructed according to the principles of the present invention;

FIG. 2 illustrates a block diagram of an embodiment of a computer system capable of automatically initiating a telephone call over a computer network constructed according to the principles of the present invention;

FIG. 3 illustrates an example of a caller number identification signals message structure used for automatically initiating a telephone call over a computer network; and

FIG. 4 illustrates a method of automatically initiating a telephone call over a computer network constructed according to the principles of the present invention.

### DETAILED DESCRIPTION

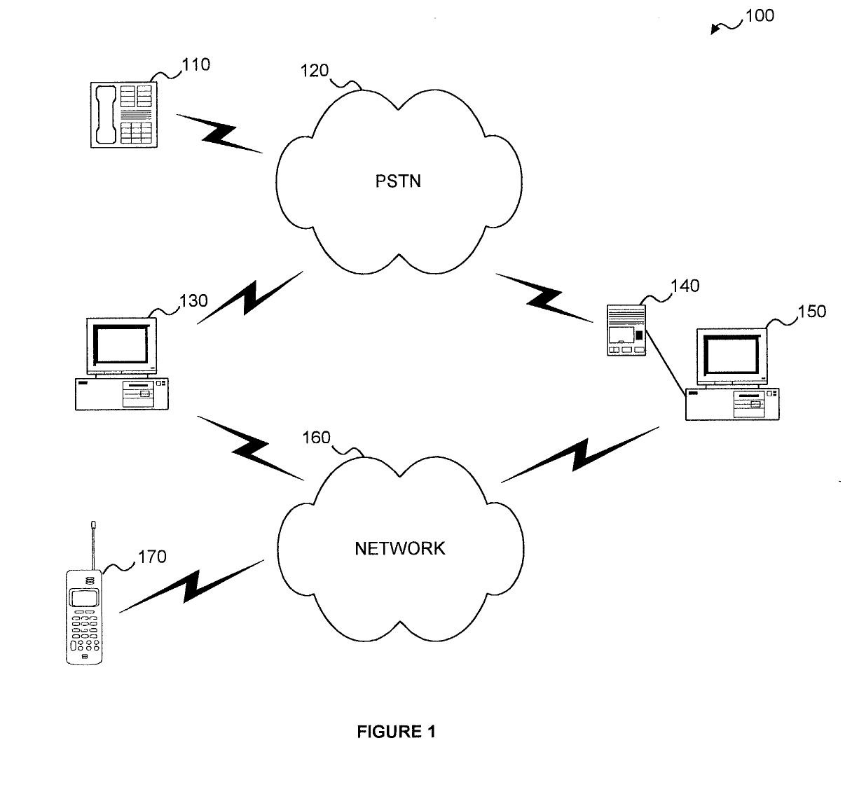

Referring initially to FIG. 1, illustrated is a system, generally designated 100, for automatically initiating a telephone call over a computer network constructed according to the principles of the present invention. The system 100 includes a telephone station 110 and destination computer system 130 connected to a public switched telephone network (“PSTN”) 120. The telephone station 110 or the destination computer system 130 can initiate a telephone call to a recipient computer system 150 through the PSTN 120 and transmit calling number identification signals (“CNIS”) to PSTN 120. The CNIS, also referred to as “Caller ID,” includes a destination address that can be used by the recipient computer system 150 to initiate a call over a computer network 160 to the destination computer system 130 or a WEB telephone 170. One skilled in the art is familiar with and the use of WEB telephones and Caller ID.

In one embodiment, a local service provider (not shown) of the PSTN 120 may accept the destination address from a subscriber, such as destination computer sytem 130, and transmit the CNIS, such as a subscriber's name and telephone number along with the destination address, through the PSTN to the recipient computer system 150. The recipient computer system 150 may employ the CNIS, such as the destination address, to initiate a call over the computer network 160 to the destination computer system 130. This advantageously allows the local service provider to avoid long distance charges of a long distance provider. One skilled in the art is familiar with and the local service providers of a PSTN and there operation.

In one embodiment, the destination address may be a telephone number, an Internet Protocol address, a Voice over Internet Protocol (“VoIP”) gateway address, or a VoIP gateway address combined with a telephone number. Background information concerning VoIP and VoIP gateways are discussed in IP Telephony Basics, by Dialogic, which is available at http://www.dialogic.com/solution/internet/4070web.htm on the World Wide Web and are incorporated herein by reference.

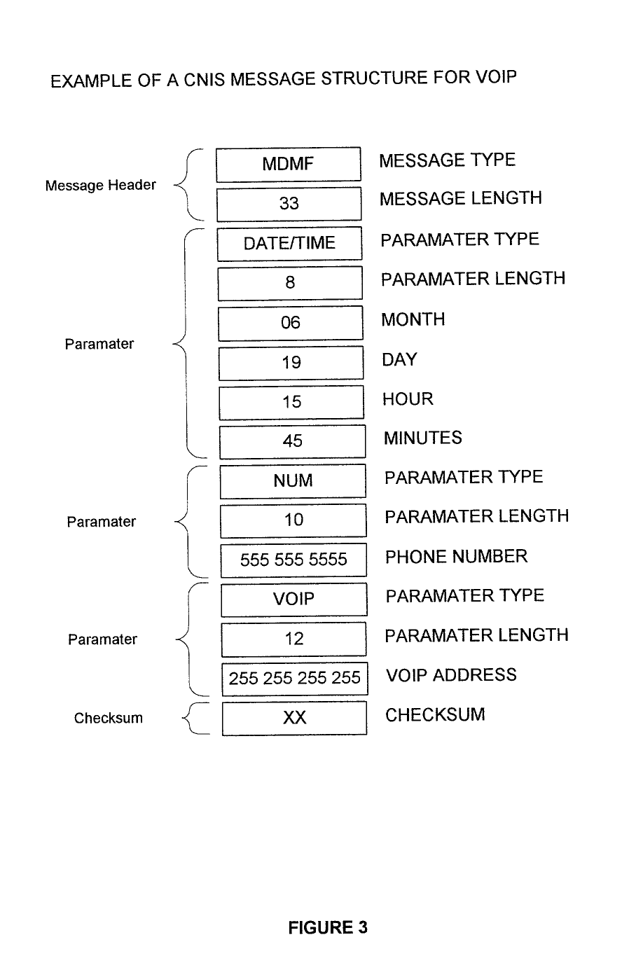

In the illustrated embodiment, the recipient computer system 150 is also coupled to an address interceptor 140 which receives the CNIS sent by the telephone station 110 or the destination computer 130. The address interceptor 140 extracts the destination address from the CNIS and sends the destination address to the recipient computer system 150. The CNIS message structure is discussed in further detail in FIG. 3. In another embodiment, the address interceptor 140 may be incorporated into the recipient computer system 150.

The recipient computer system 150, using the extracted destination address, connects to the computer network 160 and establishes a connection for voice communications to the destination computer 130 or the WEB phone 170. In one embodiment, the recipient computer system 150 uses a destination address that is a phone number connection. In another embodiment, the recipient computer system 150 uses a destination address that is a VoIP gateway address or a VoIP gateway address in combination with a telephone number to make a VoIP connection. One skilled in the pertinent art is familiar with establishing connections for voice communications over a computer network.

In the illustrated embodiment of the present invention, the computer network 160 is the Internet. In other embodiments, the computer network 160 may be a Local Area Network (“LAN”), a Wide Area Network (“WAN”), an Intranet, an Extranet, the Internet, the World Wide Web or a combination thereof.

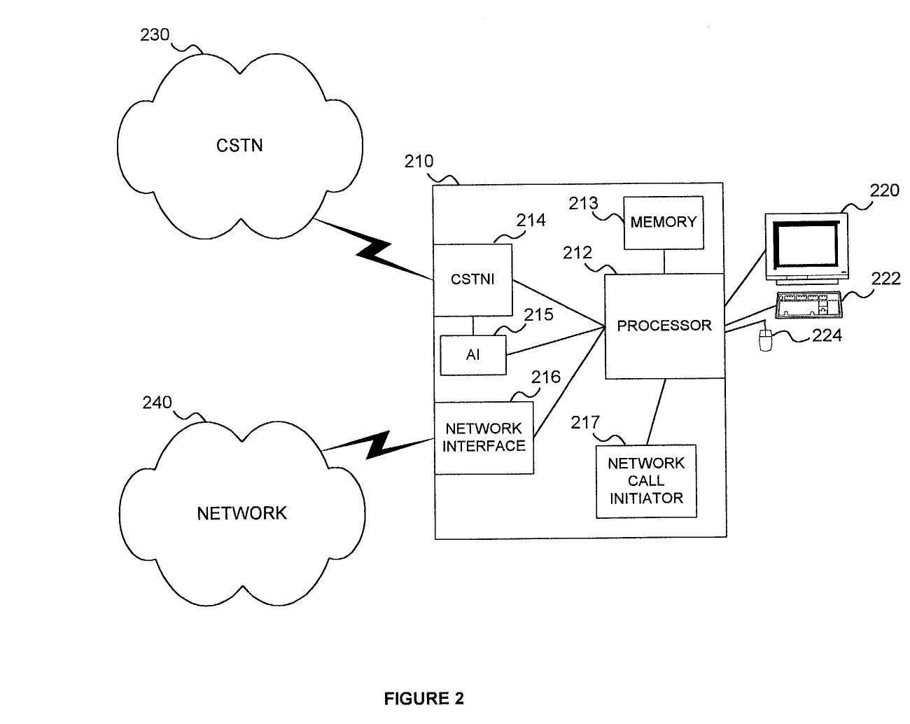

Turning now to FIG. 2, illustrated is a block diagram of an embodiment of a computer system 210 capable of automatically initiating a telephone call over a computer network constructed according to the principles of the present invention. The computer system 210 includes a processor 212 which is coupled to a monitor 220, a keyboard 222 and a pointing device 224. In the illustrated embodiment, the pointing device 224 is a conventional mouse. In another embodiment, the computer system 210 may be a specialized computer system not requiring the monitor 220, the keyboard 222 and the pointing device 224.

The computer system 210 further includes a memory 213, a circuit-switched telephone network interface (“CSTNI”) 214, an address interceptor 215, a network interface 216 and a network call initiator 217. The memory 213 is conventional memory for a computer and is coupled to the processor 212. The CSTNI 214 is coupled to the processor 212 and a circuit-switched telephone network (“CSTN”) 230 and the address interceptor 215. The CSTNI 214 receives calls from the CSTN 230 that includes calling number identifications signals (“CNIS”), which make up a CNIS message.

The address interceptor 215 receives the CNIS message from the CSTN 230 and extracts a destination address from the CNIS message. The address interceptor 215 sends the extracted destination address to the processor 212 for further processing. Background information concerning reception of CNIS messages from a CNIS is discussed in U.S. Pat. No. 4,582,956 issued to Carolyn A. Doughty, entitled “Method and Apparatus for Displaying at a Selected Station Special Service Information During a Silent Interval Between Ringing” and is hereby incorporated by reference.

Also coupled to the processor 212, are the network call initiator 217 and the network interface 216. The network call initiator 217 receives the extracted destination address from the processor 212. The network call initiator 217 determines the type of destination address received and the type of call to be made. Employing the destination address and the network interface 216, the network call initiator 217 initiates a telephone call via the computer network 240. The computer network 240 may be an LAN, a WAN, an Intranet, an Extranet, the Internet or a combination thereof.

Turning now to FIG. 3, illustrated is an example of a caller number identification signals (“CNIS”) message structure used for automatically initiating a telephone call over a computer network. The CNIS message structure consists of three basic sections: header, parameter and checksum. The first section is the header and includes the message type and the length of the message. A typical CNIS message has a message type of MDMF, which has a value of 128 decimal. The second section is the parameter section and includes a parameter type field, a parameter length field and the parameter.

In this example, the CNIS message for VoIP has three parameter sections: a date/time section, a telephone number section and a VoIP address section. The data/time section includes the month, day, hour and minutes that the call was initiated on. The telephone number section includes the telephone number of the calling party. The VoIP address section includes the VoIP address used to make a call over a computer network such as the Internet.

In one embodiment, the VoIP address is an IP address of the destination computer or device to be called. In other embodiments, the VoIP address may contain the destination telephone number, a VoIP gateway address, or a VoIP gateway address combined with a telephone number. One skilled in the pertinent art is familiar with the type of information needed to make a connection using VoIP and VoIP gateways.

The last section is the checksum section. The checksum is a twos complement of the modulo 256 sum of each bit in the message. The checksum insures that the message received is valid and does not contain erroneous information. Background information concerning caller number identification signals and message structures are discussed in “Caller ID Basics,” by Micheal W. Slawson, which is available at http://testmark.com/callerid.html on the World Wide Web and is incorporated herein by reference.

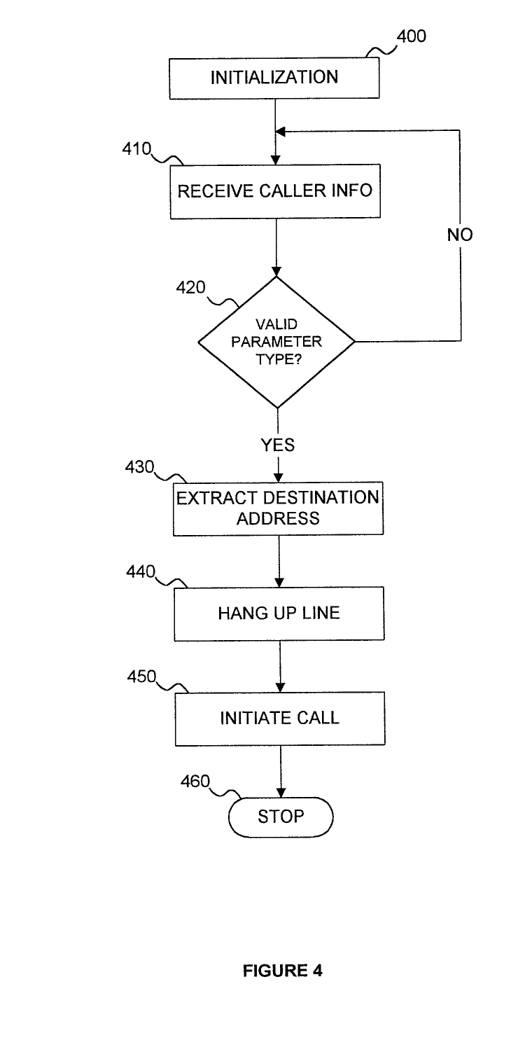

Turning now to FIG. 4, illustrated is a method of automatically initiating a telephone call over a computer network constructed according to the principles of the present invention. In FIG. 4, the system for automatically initiating a telephone call over a computer network (“system”) first performs initialization in a step 400.

After initialization, the system receives the calling number information signals (“CNIS”) from a circuit-switched telephone network (“CSTN”) call in a step 410. The system then determines if the CNIS message contains a valid parameter type in a decisional step 420. In one embodiment, the system determines if one of the parameters contains a VoIP parameter type. (See FIG. 3 for description of parameters and the CNIS message structure). In another embodiment, the system may examine the message type field for a special code.

If there was not a valid parameter type, the system returns to receive the next CNIS message in the step 410. If there was a valid parameter type, the system then extracts a destination address from the CNIS message in a step 430. In one embodiment, the CNIS information and the extracted destination address are associated with a single location. In another embodiment, the CNIS information and the extracted destination address are associated with different locations.

Next, the system will hang up the telephone line associated with the CSTN call in a step 440. In another embodiment, the system will leave the CSTN call unanswered even though the CNIS message was received. Yet in another embodiment, the system will hang up the call after as predetermined number of unanswered rings.

The system then employs the extracted destination address to initiate a telephone call over a computer network in a step 450. The computer network may be an LAN, a WAN, an Intranet, an Extranet, the Internet or a combination thereof. In other embodiments, the computer network may also contain VoIP gateways that are used in making a telephone call over the computer network.

The system then stops in a step 460. In another embodiment, the system returns to receive another CSTN call and CNIS message in the step 410.

One skilled in the art should know that the present invention is not limited to extracting only a destination address described above. Other embodiments of the present invention may have additional or fewer steps than described above.

Although the present invention has been described in detail, those skilled in the art should understand that they can make various changes, substitutions and alterations herein without departing from the spirit and scope of the invention in its broadest form.

What is claimed is:

1. A system for automatically initiating a telephone call over a computer network, comprising:
an address interceptor, associated with a station of a circuit-switched telephone network, that receives calling number identification signals from said circuit-switched telephone network and extracts therefrom a destination address; and
a network call initiator, coupled to said address interceptor and associated with a computer network terminal, that employs said destination address to initiate said telephone call via said computer network terminal.

2. The system as recited in claim 1 wherein said calling number identification signals and said destination address are associated with a single location.

3. The system as recited in claim 1 wherein said destination address is selected from the group consisting of:
a telephone number,
an Internet Protocol address,
a Voice over Internet Protocol (VoIP) gateway address, and
a VoIP gateway address combined with a telephone number.

4. The system as recited in claim 1 wherein said computer network is the Internet.

5. The system as recited in claim 1 wherein said station leaves unanswered a call transmitting said calling number identification signals.

6. The system as recited in claim 1 wherein said calling number identification signals are associated with a second station, said second station hanging up after a predetermined number of unanswered rings.

7. The system as recited in claim 1 wherein said station and said computer network terminal are embodied in a computer and wherein a single telephone line alternatively couples said station to said circuit-switched telephone network and said computer network terminal to said computer network.

8. A method of automatically initiating a telephone call over a computer network, comprising:
extracting a destination address from calling number identification signals received from a circuit-switched telephone network; and
employing said destination address to initiate said telephone call.

9. The method as recited in claim 8 wherein said calling number identification signals and said destination address are associated with a single location.

10. The method as recited in claim 8 wherein said destination address is selected from the group consisting of:
a telephone number,
an Internet Protocol address,
a Voice over Internet Protocol (VoIP) gateway address, and
a VoIP gateway address combined with a telephone number.

11. The method as recited in claim 8 wherein said computer network is the Internet.

12. The method as recited in claim 8 further comprising leaving unanswered a call transmitting said calling number identification signals.

13. The method as recited in claim 8 wherein said calling number identification signals are associated with a station, said method further comprising hanging up said station after a predetermined number of unanswered rings.

14. The method as recited in claim 8 wherein said method is carried out in a computer and wherein a single telephone line alternatively carries said calling number identification signals and said destination address.

15. A computer, comprising:
a processor;
a memory coupled to said processor;
a display coupled to said processor;
at least one input device coupled to said processor;
a circuit-switched telephone network interface, coupled to said processor, for receiving a call from a circuit-switched telephone network couplable thereto, said call including calling number identification signals;
a computer network interface, coupled to said processor, for allowing said computer to communicate over a computer network;
an address interceptor, coupled to said processor and communicable with said circuit-switched telephone network interface, for extracting a destination address from said calling number identification signals; and
a network call initiator, coupled to said processor, for employing said destination address to initiate said telephone call via said computer network interface.

16. The computer as recited in claim 15 wherein said calling number identification signals and said destination address are associated with a single location.

17. The computer as recited in claim 15 wherein said destination address is selected from the group consisting of:
a telephone number,
an Internet Protocol address,
a Voice over Internet Protocol (VoIP) gateway address, and
a VoIP gateway address combined with a telephone number.

18. The computer as recited in claim 15 wherein said computer network is the Internet.

19. The computer as recited in claim 15 wherein said circuit-switched telephone network interface leaves said call unanswered.

20. The computer as recited in claim 15 wherein a station placing said call hangs up after a predetermined number of unanswered rings.

21. The computer as recited in claim 15 wherein said circuit-switched telephone network interface and said computer network interface are coupled to a single telephone line.
